(19) United States
(12) Patent Application Publication
(10) Pub. No.: US 2024/0224353 A1
(43) Pub. Date: Jul. 4, 2024

(54) SYSTEM AND METHOD FOR CONTROLLING ACCESS

(71) Applicant: Elliptic Laboratories ASA, Oslo (NO)

(72) Inventors: Tom Øystein KAVLI, Oslo (NO); Guenael Thomas STRUTT, San Francisco, CA (US); Tobias BORÉN SVENDSEN, Oslo (NO); John Magne HELGESEN RØE, Sørumsand (NO); Erik FORSSTRÖM, Oslo (NO)

(73) Assignee: Elliptic Laboratories ASA, Oslo (NO)

(21) Appl. No.: 18/279,177

(22) PCT Filed: Feb. 22, 2022
(86) PCT No.: PCT/EP2022/054397

§ 371 Date: Aug. 28, 2023

(30) Foreign Application Priority Data
Mar. 8, 2021 (NO) 20210305

(51) Int. Cl. H04W 76/14; G06F 3/16; H04B 11/00; H04R 3/00

(52) U.S. Cl. CPC H04W 76/14; G06F 3/165; H04B 11/00; H04R 3/00; H04R 2420/07

(57) ABSTRACT

The present invention relates to a system for controlling access to an external device, including a first device and a second, external device, both including wireless communication units using a common communication protocol. One of said devices includes an acoustic transmitter being configured to transmit acoustic signals at least partially within the ultrasonic range, and the second of the devices includes an acoustic receiver configured to receive acoustic signals at least partially in the ultrasonic range. The transmitted ultrasonic signal has predetermined characteristics and said receiver being configured to recognize said characteristics and, at the receipt of said ultrasonic signal at the second device initiating a wireless communication using said communication protocol.

The present invention is related to a system and method for controlling access to an external device such as a Wi-Fi system or an external speaker system.

Public areas such as stores, coffee shops, hotels and restaurants often provide WiFi access to their customers. It is, however, difficult to limit the access to the intended area and users as the signal often will have sufficient strength to be received outside the area. In order to limit access to customers only, a variety of authentication schemes exists, such WPA/Password signs inside the location, user subscription logins, login coupons etc. Most of these schemes lacks a notion of presence in order to limit the service to customers inside the premises. In other words, one may often gain access by being within WiFi range given the authentication information. Thus there is a need for a way to control the access to an area inside the WiFi range. Similar problems are also related to other types of wireless systems such as Bluetooth used for local control of devices. US2019349758 and US2009323991 describe the use of ultrasound signals for initiating a Wi-Fi or Bluetooth connection process. They measure the distance between the devices based on round trip measurements which requires that they are in active communication before establishing Wi-Fi or Bluetooth contact.

For example the use of wifi, bluetooth and similar for playing music, podcast etc from a smart phone or other moveable devices on external speakers is well known. However, the systems are limited by the signal strength and coverage of the transmitter or communication system used to transmit the signal. For example, when a phone pairs with a bluetooth device, it may not be in range, and be playing in a room or location that the user cannot hear. It takes some time for the user to realize that the device is paired. Sometimes this happens when a device pairs with a car entertainment system. Also, a person and the device moving will experience signal drop-outs and failures as they move, and even if the system includes other speakers the user has to change between them manually. While some system allows multiroom solutions the playback still has to be controlled by the user who may experience the dropouts when moving too far from any selected speakers, and also playing the music in all rooms may be annoying to other persons in the vicinity.

Therefore, there is a need for a system capable of providing access to a wireless system close to the user device. This is obtained as specified in the accompanying claims.

According to the invention the ultrasound can be used to determine if a mobile phone or similar device such as a laptop are located close to a wireless system having a speaker or a Bluetooth speaker when accessing the wireless system. In most cases the present invention will not require hardware changes as long as one of the devices has a speaker and the other has a microphone, both being capable of transmitting and receiving signals in the near ultrasound range.

In the case of a Bluetooth playback system the mobile device provides a signal to the speaker making the speaker transmit sound outside hearing range, such as close ultrasound that may still be in the range available to the speaker. The strength of that sound will provide an indication of the distance from the speaker and therefore also an indication of the signal reception at the speaker unit.

When the speaker is sufficiently far from the mobile device the device may look for another speaker, and if finding one, notifies the user that another speaker having better reception is close by. The user may then choose the new speaker unit manually of the mobile device has been set to switch automatically.

The invention will be described more in detail below with reference to the accompanying drawings, illustrating the invention by way of examples.

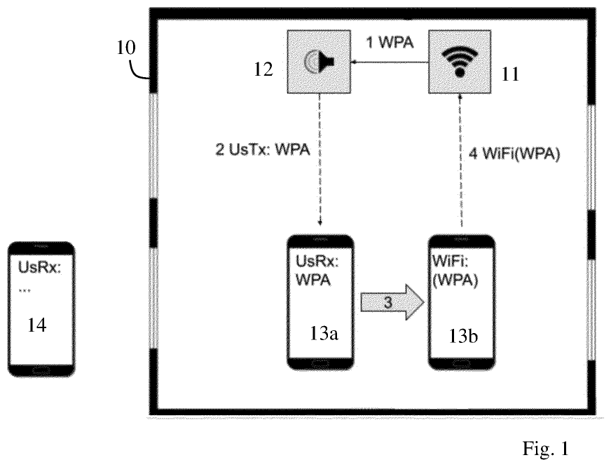

FIG. 1 illustrates an access control according to the present invention.

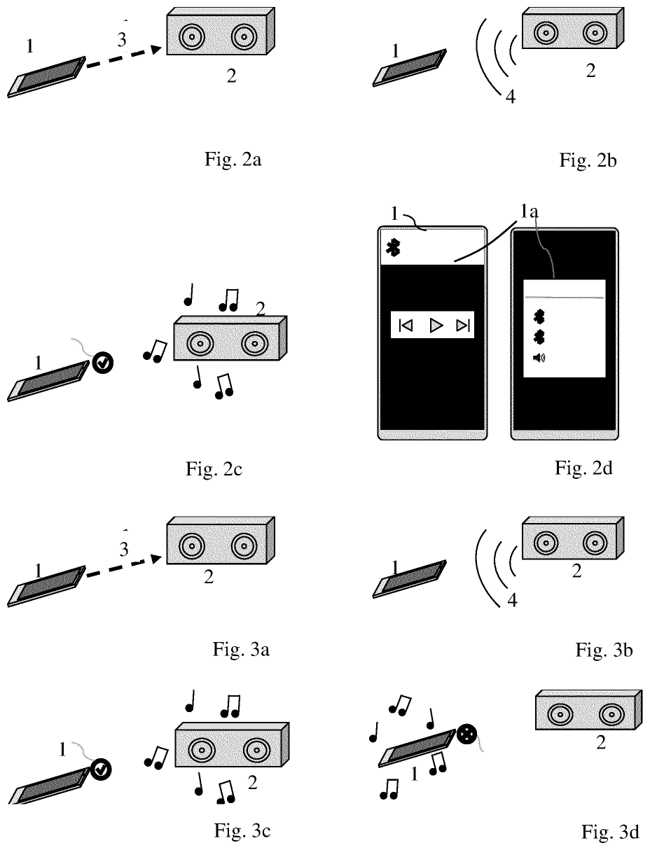

FIG. 2a-d illustrates a sequence of operation according to the invention when a speaker is close to the device.

FIG. 2a-d illustrates the sequence of operation according to the invention when the speaker is not close enough.

FIG. 4 illustrates a device according to the invention.

FIG. 1 illustrates a general use of the system where the access to a WiFi system is limited to a defined room 10. A router with a specific WPA may at predetermined intervals transmit the WPA to a speaker unit 12. The speaker unit may transmit an ultrasonic signal The ultrasonic signal is preferably in the near ultrasonic range, just outside the audible range in order to use speakers and microphones with known characteristics.

The speaker unit preferably transmits the WPA code included into the ultrasonic signal, and as the ultrasonic signal has a limited range the signal can only be received by device microphone units 13a present in the room. The device microphone unit 13a forwards the WPA to the device WiFi unit which transmits it to the local WiFi router and automatically gains access. A device 14 located outside the room 10 will not be able to detect the ultrasonic signal and thus be able to get access.

Using this embodiment the router 11 may change the WPA without anyone noticing, but requires that the mobile devices have activated their microphones.

According to another embodiment the device may be configured to emit the ultrasonic signal along with an identity code also transmitted when trying to access the WiFi. For example the WiFi access code is transmitted both with ultrasonic signal and with normal access procedures, while the router only allows access when both WiFi and ultrasonic signals have been received. In this case the acoustic signal strength may also be used to indicate the user distance from the router and thus calculate the likelihood of the device being within the predetermined access area. 10.

FIG. 2a shows an electronic device 1 according to the invention transmitting a first signal 3 to a speaker system 2. The electromagnetic signal 3 may be using Bluetooth, Airplay, WiFi or similar systems being activated by the user, e.g. through a software application or button. The signal 3 includes an instruction to the speaker to emit a sound at a frequency outside the normal hearing range but within the known frequency range of the speaker as well as a microphone on the device 1.

FIG. 2b illustrated that the speaker transmits the ultrasound signal 4 specified in the first signal 3.

As illustrated in FIG. 2c, if the ultrasound signal 4 is received and recognized by the device 1 the device transmits signals, e.g. representing music, as is well known in the art. If the ultrasound signal is not received and recognized by the device 1 the user may be notified on the device display 1a, as illustrated in FIG. 1d, and be informed about other possible connections and/or be allowed to override the system by playing on the first speaker 2.

This way improved control of the audio playback experience may be provided.

In a practical implementation of the invention in a device a phone is paired and connected with a Bluetooth speaker. When a user presses the play button of a custom music app on the phone a short .wav file, or corresponding formats, containing an ultrasonic signal is played before the selected music is played. On the phone, a custom sensor is opened that listens for the ultrasonic signal from the speaker.

If the ultrasonic signal is recognized by the phone, one action happens. If the signal is not recognized another action happens.

The ultrasonic signal is sent at the maximum possible volume to achieve maximum range. After the ultrasonic signal has been sent, the normal audio will play at the media volume that is defined by the sending device.

According to one example, independent of the room detection response, audio starts to play through the connected speaker. If the ultrasonic signal is not detected by the phone, a notification is displayed allowing the user to play from the phone or to select another playback device instead. The notification gives the user a fast way to switch audio outputs.

On some phones, when you make a phone call it opens a menu with the choice of audio outputs. This may include a default selection where the ultrasound goes through the set audio output is used as illustrated in FIG. 2c. If the default fails (ultrasound does not go through), the device opens a menu saying “the audio device seems to be out of range, do you want to switch?”, as illustrated in FIG. 1d.

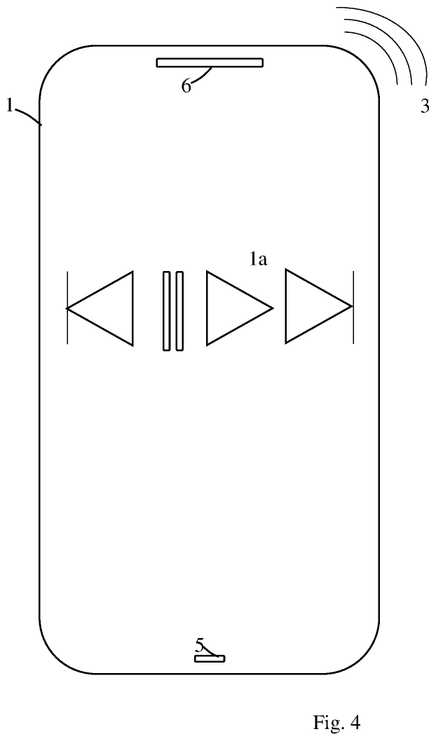

According to another example, illustrated in FIGS. 3a-3d, if the ultrasonic signal 4 is detected by the phone 1, audio start to play directly through the connected speaker 2. If the signal is not detected, audio starts to play through the phone 1. Another option is that the device transmits the ultrasound file in intervals and automatically chooses the closest available speaker based on the strength of the received ultrasound signal.

FIG. 4 illustrates an electronic device, for example a mobile phone 1 being adapted to transmit an electromagnetic signal 3 representing a sound signal, e.g. through Bluetooth, Airplay or WiFi. The device also comprises a display 1a for showing notifications and controls to the user. The device also includes a microphone 5, the ultrasound signal being chosen so as to be within the sensitivity range of the microphone. The device also includes a speaker 6.

Bluetooth standard AVCRP Version 1.4 of the Audio/Video Remote Control Profile includes support for absolute volume between devices. The volume is synced between the device that transmits the audio and the device that receives the audio allowing the volume controls of the audio device to control the audio volume of the sending device and vice versa.

The volume button of a Bluetooth speaker will control the media volume of the phone and the volume buttons of the phone will control the volume of the Bluetooth speaker.

Ultrasound needs to be sent at maximum volume of the speaker to achieve maximum detection range by the phone. Without the volume synchronization of the devices the functionality could be perceived to function randomly since the volume of the speaker could be set to a minimum level without the user being aware of this.

Even though AVRCP is a standard part of the Bluetooth protocol some manufacturers like Xiaomi does not implement the protocol correctly resulting in two separate volumes.

When AVRCP is implemented according to the specification, the ultrasonic signal can be played at maximum volume and the following normal audio can be played by the volume dictated by the playing device.

To ensure reliability, the waveform of the ultrasound signal should be recognizable by the phone. An encoded message with, say, a six-bit (64 possibilities) message with some error detection encoding (2-bit check) would ensure that the correct message is heard (in the event of collisions with another system).

To summarize the system according to the invention relates to controlling access to an external device, including a first device and a second, external device. Both devices include wireless communication units using a common communication protocol. One of the devices includes an acoustic transmitter being configured to transmit acoustic signals at least partially within the ultrasonic range and the second of said of said devices includes an acoustic receiver configured to receive the transmitted acoustic signals in the same range. The transmitted ultrasonic signal have predetermined characteristics, including a sufficient signal strength and the receiver is configured to recognize the characteristics and, at the receipt of said ultrasonic signal at the second device, initiating a wireless communication using the communication protocol. The signal strength may be required to be above a predetermined limit which may be set by an operator based on local circumstances, such as size of the allowed area and background noise.

According to one embodiment the first device is a wireless router such as a WiFi router being connected to a speaker that is capable of transmitting the ultrasonic signal. The ultrasonic signal then includes information recognizable to the external device receiving it. The external device is configured to, at the receipt of the recognizable information, transmit, using the wireless protocol, the recognizable signal to the first device, the recognizable signal including an access code for communicating with said router.

According to a second embodiment the first device is a media unit such as a screen or a speaker, the initiated wireless communication is aimed at allowing access to control the media unit.

The media unit is preferably includes a speaker, said external device being adapted to, using said wireless protocol to transmit signals to be received by the speaker, the external device also including a storage including a file representing an ultrasonic signal with a known amplitude and frequency range. The external device is adapted to transmit said file to said speaker, and the external device includes a microphone capable of receiving said ultrasonic signal frequency range and an analyzing unit for recognizing said ultrasonic signal and, if received, providing a playback of user chosen files in the external device on said speaker.

The external device may also include a display wherein an analyzing unit in the external device, when said ultrasonic signal level is below the predetermined threshold, provides a notification on the device display, notifying insufficient signal strength and possibly too large distance to the speaker.

The external device may also include an interface for providing user feedback, and wherein the notification allows the user to choose if the speaker is to be used.

The wireless signal may be a Bluetooth signal or other wireless protocols, and the ultrasound playback file may include a command specifying the playback amplitude of the ultrasonic signal.

The present invention also relates to a method for using an external device for accessing control of a first device, the devices including a wireless communication units and at least one of the devices including a microphone and the other including a speaker,

The method includes the steps of:

Transmitting an ultrasonic signal from one of said devices to the other, the ultrasonic signal including predetermined characteristics, such as encoding, frequency distribution etc. The other device, at the receipt of the ultrasonic signal having said predetermined characteristics, provides access to said wireless communication.

The wireless communication units include a radio transmitter and receiver, and the method includes step of, through the radio transmitter, transmitting a signal in a protocol suitable for being received by an external speaker, the signal including a file representing an ultrasonic sound to be played by said speaker. Using the microphone, sensing if an acoustic signal corresponding to the ultrasonic sound occurs. If the ultrasonic sound is not received, the user may be notified using a display, speaker, etc, or, if the ultrasonic sound is received, a playback signal is transmitted through the wireless communication to the external speakers, e.g. thus playing a music file.

The external device may include a display which, when said ultrasonic signal is below the predetermined threshold, is configured to prove a notification on the device display.

In case more than one speakers are in the vicinity receiving the initial signal from the external device may include an interface for providing user feedback, allowing the user to choose if the external speaker is to be used. The speakers may be configured to identify themselves through the ultrasound signal or wireless signal, thus allowing the device to recognize the received ultrasonic signal.

1. A system for controlling access to an external device, comprising a first device and a second, external device, both comprising wireless communication units using a common communication protocol, wherein one of the devices comprises an acoustic transmitter being configured to transmit acoustic signals at least partially within the ultrasonic range, and the second of the devices comprises an acoustic receiver configured to receive acoustic signals at least partially in the ultrasonic range, the transmitted ultrasonic signal having predetermined characteristics and the receiver being configured to recognize the characteristics as well as the signal strength of the acoustic signal and, at the receipt of the ultrasonic signal at a sufficient strength at the second device initiating a wireless communication using the communication protocol.

2. The system according to claim 1, wherein the first device is a wireless router, the router being connected to a speaker being configured to transmit the ultrasonic signal, the ultrasonic signal comprising information recognizable to the external device, the external device being configured to, at the receipt of the recognizable information, transmit, using the wireless protocol, the recognizable signal to the first device, the recognizable signal comprising an access code for communicating with the router.

3. The system according to claim 1, wherein the first device is a media unit, the initiated wireless communication allowing access to control the media unit.

4. The system according to claim 3 wherein the media unit is a speaker, the external device being adapted to, using the wireless protocol to transmit signals to be received by the speaker, the external device also comprising a storage comprising a file representing an ultrasonic signal with a known amplitude and frequency range, wherein the external device is adapted to transmit the file to the speaker, wherein the external device comprises a microphone capable of receiving the ultrasonic signal frequency range and an analyzing unit for recognizing the ultrasonic signal and, if received, providing a playback of user chosen files on the speaker.

5. The system according to claim 4, the external device comprising a display wherein the analyzing unit, when the ultrasonic signal is below the predetermined threshold, provides a notification on the device display.

6. The system according to claim 5, wherein the external device comprises an interface for providing user feedback, and wherein the notification allows the user to choose if the speaker is to be used.

7. The system according to claim 1, wherein the wireless signal is a Bluetooth signal.

8. The system according to claim 4, wherein the ultrasound playback file comprises a command specifying the playback amplitude of the ultrasonic signal.

9. A method for using an external device for accessing control of a first device, the devices comprising a wireless communication units and at least one of the devices comprising a microphone and the other comprising a speaker, the method comprising:
transmitting an ultrasonic signal from one of the devices to the other, the ultrasonic signal comprising predetermined characteristics, the other device, at the receipt of the ultrasonic signal with a sufficient signal strength, providing access to the wireless communication.

10. The method according to claim 9, wherein the wireless communication units include a radio transmitter, the method comprising, through the radio transmitter, transmitting a signal in a protocol suitable for an external speaker, the signal comprising a file representing an ultrasonic sound to be played by the speaker,
sensing, using the microphone, if an acoustic signal corresponding to the ultrasonic sound occurs, and,
if the ultrasonic sound is not received, notifying the user, or, if the ultrasonic sound is received, transmitting a playback signal to the external speakers.

11. The method according to claim 9, wherein the external device comprises a display, when the ultrasonic signal is below the predetermined threshold, providing a notification on the device display.

12. The method according to claim 9, wherein the external device comprises an interface for providing user feedback, allowing the user to choose if the external speaker is to be used.

13. The method according to claim 9, wherein the wireless signal is a Bluetooth signal.

14. The method according to claim 9, wherein the ultrasound playback file comprises a command specifying the playback amplitude of the ultrasonic signal.

15. The method according to claim 9, wherein the ultrasonic signal is coded with specific characteristics, thus allowing the device to recognize the received ultrasonic signal.

16. A computer implemented software product implemented in a mobile electronic device, wherein the product when executed in the device performs the method of claim 9.
